(19) United States
(12) Patent Application Publication
(10) Pub. No.: US 2013/0133965 A1
(43) Pub. Date: May 30, 2013

(54) VEHICLE BRAKING MANAGEMENT FOR A HYBRID POWER TRAIN SYSTEM

(71) Applicant: Martin T. Books, Columbus, IN (US)

(72) Inventor: Martin T. Books, Columbus, IN (US)

(21) Appl. No.: 13/307,812

(22) Filed: Nov. 30, 2011

(51) Int. Cl. B60K 6/48; B60T 7/00; B60K 25/00; G06F 19/00

(52) U.S. Cl. 180/165; 701/70; 180/65.25; 701/71; 903/947

(57) ABSTRACT

An exemplary system includes a vehicle having a drive wheel mechanically coupled to a drive shaft of a hybrid power train. The hybrid power train includes an internal combustion engine and an electric motor selectively coupled to the drive shaft. The internal combustion engine including a compression braking device. The system includes an electric generator selectively coupled to the drive shaft and coupled to an electrical storage device. The system includes a brake pedal position sensor that provides a braking request value. The system includes a controller configured to interpret the braking request value, a regenerative braking capacity, and a compression braking capacity. The controller is further configured to provide a regenerative braking command and a compression braking command in response to the braking request value, the regenerative braking capacity and the compression braking capacity.

### BACKGROUND

Environmental concerns and limited natural resources are driving modern internal combustion engines toward improved fuel efficiency. A hybrid power train is one system that can be used to improve the fuel efficiency of an engine. Hybrid power trains include at least two power sources, with at least one of the power sources including energy storage capability that can be utilized during at least certain operating conditions to recover kinetic energy from a moving vehicle. In some systems, for example a system including a generator coupled to an electrical energy storage device, regenerative braking capacity to recover the kinetic energy reduces with the vehicle speed and driveline rotating speed of the power train system. Accordingly, presently available hybrid power trains continue to require the use of a significant amount of conventional friction braking. Friction brakes wear down over time and use, and must be maintained or replaced, increasing operating costs and potential causing vehicle down time. Therefore, further technological developments are desirable in this area.

### SUMMARY

One embodiment is a unique method for controlling braking in a hybrid power system. Further embodiments, forms, objects, features, advantages, aspects, and benefits shall become apparent from the following description and drawings.

### BRIEF DESCRIPTION OF THE DRAWINGS

FIG. 1 is a schematic block diagram for managing hybrid power train braking.

FIG. 2 is a schematic view of a controller that functionally executes certain operations for managing hybrid power train braking.

FIG. 3 is an illustrative schedule of hybrid power train braking operations in response to a brake request value.

FIG. 4 is a second illustrative schedule of hybrid power train braking operations in response to a brake request value.

FIG. 5 is a schematic flow diagram of a procedure for managing hybrid power train braking.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

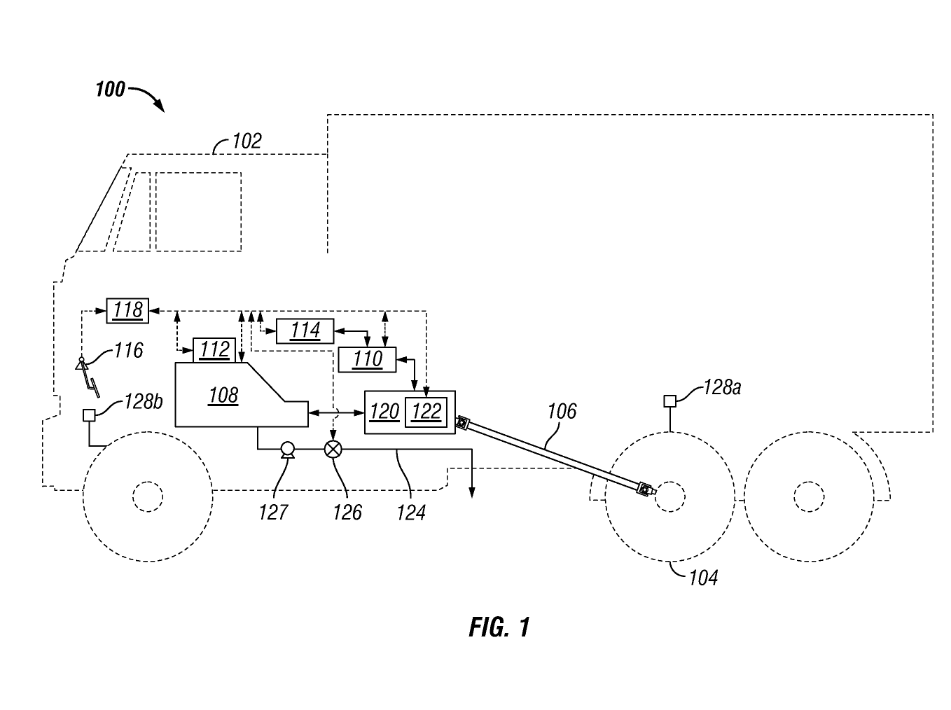

Referencing FIG. 1, an exemplary system 100 includes a hybrid power train having an internal combustion engine 108 and an electric motor 110 selectively coupled to a drive shaft 106. The system 100 includes an electric motor 110, but any alternative power source is contemplated herein, including at least a hydraulic motor or pump (not shown). The engine 108 may be any type of internal combustion engine known in the art. In the example of FIG. 1, the engine 108 and electric motor 110 are coupled to the driveshaft 106 through a transmission 120 having a power splitter (not shown). However, any hybrid configuration known in the art, including at least series, parallel, and series-parallel, is contemplated herein.

The system 100 further includes an energy accumulation device, such as an electric generator, that is selectively coupled to the drive shaft 106 and further coupled to an energy accumulation device. The system 100 includes an electrical storage device 114 that stores the accumulated energy. The accumulated energy may alternatively or additionally be provided to an ultra-capacitor, be provided to service an active electrical load in the system 100, or stored in any other manner.

The electric generator in FIG. 1 is included with the electric motor 110 as an electric motor/generator. However, the electric generator may be a separate device. The electric generator is structured to convert vehicle kinetic energy (or load energy) into electrical energy. In various embodiments, the system 100 includes any energy accumulation device that converts vehicle kinetic energy (or load energy) energy available to the alternative power source, such as a hydraulic power recovery unit.

The system 100 further includes a negative torque request device 116 that provides a braking request value. An exemplary negative torque request device includes a brake pedal position sensor. However, any device understood in the art to provide a braking request value, or a value that can be correlated to a present negative torque request for the hybrid power train is contemplated herein. Without limitation, a hybrid power train governing switch or input (e.g. PTO or cruise control input), a network or datalink parameter communicating a braking request value, and/or a radar-based automated braking system that provides a braking request are contemplated herein.

The system 100 further includes a controller 118 having modules structured to functionally execute operations for managing hybrid power train braking. In certain embodiments, the controller 118 forms a portion of a processing subsystem including one or more computing devices having memory, processing, and communication hardware. The controller 118 may be a single device or a distributed device, and the functions of the controller 118 may be performed by hardware or software.

In certain embodiments, the controller 118 includes one or more modules structured to functionally execute the operations of the controller 118. The controller 118 includes a negative torque module that interprets the braking request value, a system capability module that interprets a regenerative braking capacity and a mechanical braking capacity, and a braking control module that provides a regenerative braking command, a mechanical braking command, and a friction braking command in response to the braking request value, the regenerative braking capacity, and the mechanical braking capacity.

Additionally or alternatively, the controller includes a negative torque module that interprets the braking request value, a system capability module that interprets a regenerative braking capacity and a compression braking capacity, and a braking control module that provides a regenerative braking command and a compression braking command in response to the braking request value, the regenerative braking capacity and the compression braking capacity.

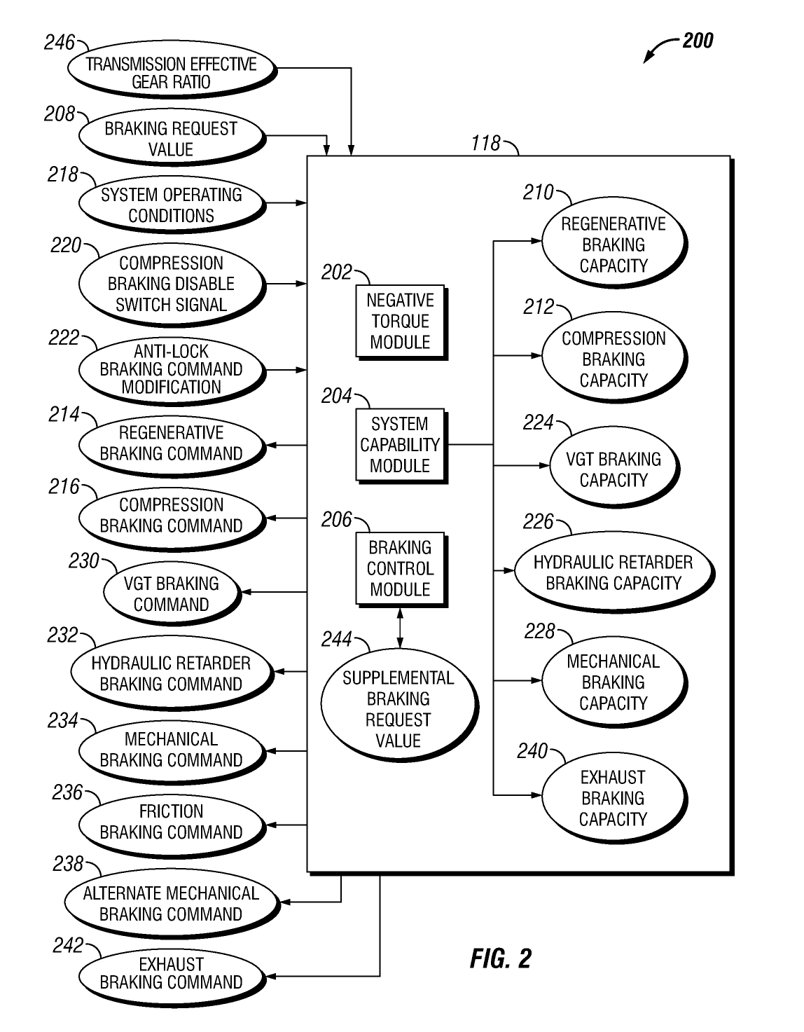

The description herein including modules emphasizes the structural independence of the aspects of the controller 118, and illustrates one grouping of operations and responsibilities of the controller 118. Other groupings that execute similar overall operations are understood within the scope of the present application. Modules may be implemented in hardware and/or software on computer readable medium, and modules may be distributed across various hardware or software components. More specific descriptions of certain embodiments of controller operations are included in the section referencing FIG. 2.

Certain operations described herein include interpreting one or more parameters. Interpreting, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a computer readable medium, receiving the value as a run-time parameter by any means known in the art, and/or by receiving a value by which the interpreted parameter can be calculated, and/or by referencing a default value that is interpreted to be the parameter value.

In certain embodiments, the system 100 includes the drive shaft 106 mechanically coupling the hybrid power train to a vehicle drive wheel 104. The system 100 may include any other type of load than a drive wheel 104, for example any load that includes stored kinetic energy that may intermittently be slowed by any braking device included in the hybrid power train. An exemplary system 100 includes a mechanical braking device that is responsive to the mechanical braking command.

An exemplary mechanical braking device includes a compression braking device 112, for example a device that adjusts the valve timing of the engine 108 such that the engine becomes a torque absorber rather than a torque producer. Another exemplary mechanical braking device includes an exhaust throttle 126 (or exhaust brake) that, in moving toward a closed position, partially blocks an exhaust stream 124 and applies back pressure on the engine resulting in a negative crankshaft torque amount. Yet another exemplary mechanical braking device is a variable geometry turbocharger (VGT) 127. Certain VGT 127 devices can be adjusted to produce back pressure on the engine 108 and provide a braking effect. Still another exemplary mechanical braking device includes a hydraulic retarder 122. The hydraulic retarder 122, where present, is typically incorporated with the transmission 120. The mechanical braking device may be any braking device which is not the conventional friction brakes of the vehicle (or application for a non-vehicle embodiment) or the electric motor/generator 110, and the described examples are not exclusive.

In certain embodiments, the system 100 includes a compression braking disable switch (not shown). The compression braking disable switch indicates that engine compression braking is not to be utilized when the switch is in a certain position. The use of a compression braking disable switch is common in cities or other areas where compression braking is not allowed by regulation. The compression braking disable switch may be any device that generates a signal indicating that compression braking is disabled, and may be a toggle, rocker, push-button, or software implemented switch.

In one form, the system includes an anti-lock braking system 128a, 128b that provides an anti-lock braking command modification. The anti-lock braking system 128a, 128b may be any type understood in the art. Anti-lock braking systems reduce braking power on the wheels in certain situations to reduce or eliminate uncontrolled slipping of the wheels. Accordingly, the controller 118, in certain embodiments, receives the anti-lock braking command modification and adjusts the braking request value and/or braking commands in response.

FIG. 2 is a schematic view of an apparatus 200 including a controller 118 for hybrid power train braking management. The exemplary controller 118 includes a negative torque module 202 that interprets a braking request value 208. The braking request value 208 is a quantitative description of an amount of braking requested for the application. An exemplary braking request value 208 is a brake pedal position provided by a brake pedal position sensor and/or provided by a network, datalink, or software-based communication. The brake pedal position is correlated to a negative torque request, or a braking torque request. The correlation may be determined as a function providing a braking power amount corresponding to a brake pedal depression amount. The determination of negative torque in response to the braking request value may further be a function of a vehicle speed, drive shaft speed, transmission gear, or other variables understood in the art.

The exemplary controller 118 further includes a system capability module 204 that interprets a regenerative braking capacity 210 and a mechanical braking capacity 228. In certain embodiments, the regenerative braking capacity 210 is the negative torque and/or negative power available from the electric generator or motor/generator under the present operating conditions. Generally, the negative torque available to the generator is dependent upon the shaft speed of the generator. Without limitation, the temperature of the generator, the present capabilities of any power electronics associated with the generator to manage electrical flux, the present capability of an electrical storage system to receive charge (e.g. due to state-of-charge or electrical flux considerations), and/or the present capability of any dissipative system (e.g. a resistor bank) to accept electrical flux may be considered in determining the regenerative braking capacity 210, dependent upon the components and considerations relevant to a particular system.

In certain alternative or additional embodiments, the regenerative braking capacity 210 is the negative torque and/or negative power available for the energy converter to provide to the energy accumulation device. An example regenerative braking capacity 210 includes a braking capacity of a hydraulic power recovery unit, and/or an energy storage capacity (or energy storage flux capacity) of a hydraulic accumulator.

The mechanical braking capacity 228 includes the braking capacity of any components in the system that are capable of applying negative torque to the drive shaft and that are not either the regenerative components or the conventional friction braking components. An exemplary and non-limiting list of mechanical braking components includes a compression brake for the engine, a VGT capable of providing braking power, an exhaust throttle and/or exhaust brake, a hydraulic retarder, and an electrical motor providing motive force in the opposite direction of the drive shaft. The system capability module 204 may determine the total mechanical braking capacity 228 as an aggregate, and/or individual braking capacities, such as a compression braking capacity 212, a VGT braking capacity 224, a hydraulic retarder braking capacity 226, and/or an exhaust braking capacity 240. The determination of the capacities 228, 212, 224, 226, 240 are dependent upon various operating conditions that vary for each component and that are generally known in the art.

In certain embodiments, any energy developed from electrical braking and/or hydraulic braking that is converted into useful energy is treated as regenerative braking and considered in the regenerative braking capacity 210, while any energy that is not converted into useful energy is treated as mechanical braking and considered in the mechanical braking capacity 218. For example, electrical dissipation may be treated as regenerative braking capacity 210 when the heat generated thereby will be utilized (e.g. to heat a passenger cabin) and as mechanical braking capacity 218 when no useful sink for the heat generated thereby is available. In certain embodiments, all energy developed from the regenerative braking device (e.g. the generator and/or the hydraulic power recovery unit) is treated as regenerative braking. In alternate embodiments, only energy provided to an energy accumulation device is treated as regenerative braking.

The exemplary controller 118 further includes a braking control module 206 that provides a regenerative braking command 214, a mechanical braking command 234, and a friction braking command 236 in response to the braking request value 208. The regenerative braking command 214 is the command to the generator(s) and/or motor/generator(s) to provide negative torque to the drive shaft.

In one form, the braking control module 206 provides the regenerative braking command 214, the mechanical braking command 234, and the friction braking command 214 by maximizing, in order, first the regenerative braking command 214 and then the mechanical braking command 234, until the braking request value 208 is achieved. The friction braking command 236 is then applied to the extent necessary to achieve the braking request value 208. The mechanical braking command 234 may be divided into one or more of a compression braking command 216, a VGT braking command 230, a hydraulic retarder braking command 232, and/or an exhaust braking command 242. The command list provided is not exhaustive, and any other braking device in the system may receive a braking command individually, or be included under the mechanical braking command 234. The various braking devices are responsive to the braking commands 214, 216, 230, 232, 234, 236, 242. For example, a master cylinder pressure or other control mechanism is manipulated to provide the braking indicated by the friction braking command 236.

In certain further embodiments, the system capability module 204 interprets the regenerative braking capacity 210 and/or the mechanical braking capacity 228 in response to an effective gear ratio 246 of the transmission. For example, if the regenerative braking capacity 210 is normalized to equivalent torque generated by an engine compression brake on the engine crankshaft, the regenerative braking capacity 210 as a torque limit is adjusted by the effective gear ratio 246 of the transmission (which may account for a torque converter, etc.). Where the regenerative braking capacity 210 is limited by presently available energy storage, the system capability module 204 may or may not utilize the effective gear ratio 246 of the transmission. In one example, the total amount of work available to be stored by the energy storage is utilized to limit the regenerative braking capacity 210, and is not affected by the effective gear ratio 246 of the transmission.

In certain embodiments, the system capability module 204 interprets the mechanical braking capacity 228 in response to the effective gear ratio 246 of the transmission to convert the mechanical braking capacity 228 to an equivalent transmission tailshaft torque, and/or to an equivalent braking load torque (e.g. accounting for any intervening torque multiplication devices), and/or to any other selected torque standard. In certain embodiments, the system capability module 204 does not adjust the mechanical braking capacity 228 in response to the effective gear ratio 246 of the transmission. In certain embodiments, the negative torque module 202 interprets the braking request value 208 in response to the effective gear ratio 246 of the transmission. It is a mechanical step for one of skill in the art, having the benefit of the disclosures herein, to provide a negative torque module 202, system capability module 204, and braking control module 206 that interpret the braking request value 208, to interpret any braking capacity 210, 212, 224, 226, 228, 240, and/or to provide any braking command 214, 216, 230, 232, 234, 236, 238, 242 in response to the effective gear ratio 246 of the transmission.

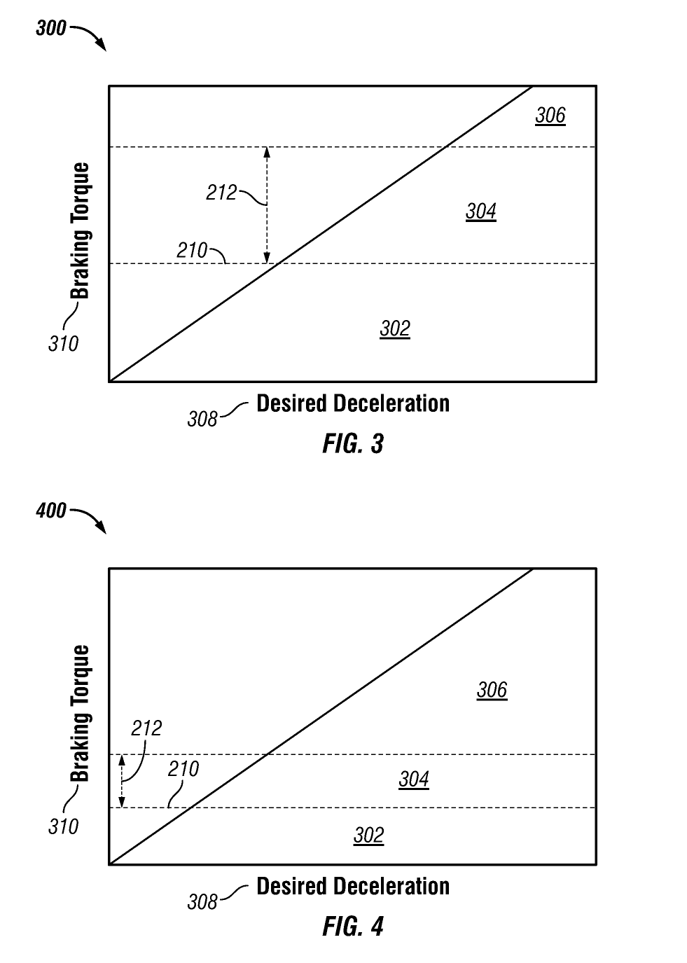

Referencing FIG. 3, an exemplary relationship 300 between desired deceleration 308 and required braking torque 310 is illustrated. The illustration is for a system in a low transmission gear where regenerative braking (the region 302) has a relatively high regenerative braking capacity 210, and engine compression braking (the region 304) has a relatively high compression braking capacity 212. As the braking torque 310 rises, with the specific operating point on the curve representing the braking request value 208, the regenerative braking 302 is initially fully capable of providing all required braking. When the regenerative braking capacity 210 is exceeded, the engine compression braking 304 commences. When the compression braking capacity 212 is exceeded, the friction braking 306 is provided to the extent required to achieve the braking request value 208.

Referencing FIG. 4, an exemplary relationship 400 between desired deceleration 308 and required braking torque 310 is illustrated. The illustration is for a system in a high transmission gear where regenerative braking (the region 302) has a relatively low regenerative braking capacity 210, and engine compression braking (the region 304) has a relatively low compression braking capacity 212. As the braking torque 310 rises, with the specific operating point on the curve representing the braking request value 208, the regenerative braking 302 is initially fully capable of providing all required braking. When the regenerative braking capacity 210 is exceeded, the engine compression braking 304 commences. When the compression braking capacity 212 is exceeded, the friction braking 306 is provided to the extent required to achieve the braking request value 208.

In the illustrations of FIG. 3 and FIG. 4, the regenerative braking capacity 210 is illustrated at a constant value with desired deceleration 308. The regenerative braking capacity 210 may vary over time, and the illustrations of FIG. 3 and FIG. 4 represent only a particular moment in time and a particular operating state of the system. In the illustrations of FIG. 3 and FIG. 4, the compression braking capacity 212 represents the entire mechanical braking capacity 228. In certain embodiments, a particular order of mechanical braking contributors may be desirable, and the mechanical braking contributors may then be added in a particular sequence until all mechanical braking options are applied, at which point the friction braking is applied to achieve the braking request value 208. In alternate embodiments, the engagement order of one or more mechanical braking contributors may not matter, and the braking control module 206 provides a mechanical braking command 234 up to the value of the mechanical braking capacity 228, with the various mechanical braking contributors combining in any manner to achieve the mechanical braking command 234.

In certain embodiments, the negative torque module 202 interprets an anti-lock braking command modification 222, and adjusts the braking request value 208 in response to the anti-lock braking command modification 222. For example, an anti-lock brake system may request a momentary reduction in braking torque, and the negative torque module 202 reduces the braking request value 208 such that the overall braking torque matches the braking torque required by the anti-lock brake system.

In certain embodiments, the system capability module further interprets the compression braking capacity 212 in response to the compression braking disable switch signal 220. For example, an operator may have a device capable of communicating to the controller 118 that engine compression braking is presently unavailable (e.g. to comply with a local ordinance). Accordingly, the system capability module 204 determines that the compression braking capacity 212 is zero in response to the compression braking disable switch signal 220. In certain embodiments, the system capability module 204 determines that engine compression braking is unavailable, and provides an alternate mechanical braking command 238 in response to the engine compression braking being unavailable. The alternate braking command 238, in one form, is the VGT braking command 230. Additionally or alternatively, the alternate braking command 238 is a hydraulic retarder braking command 232, and/or an exhaust braking command 242. The alternate braking command 238 is a mechanism to engage a braking type that may be undesirable during engine compression braking operations (e.g. an exhaust throttle), but is otherwise desirable when the engine compression braking is disabled.

In certain embodiments, an operator may have a device capable of communicating to the controller 118 that engine compression braking should only be operated at a fraction of a total engine compression braking limit. For example, a switch may be present for the operator to indicate that only 50% compression braking power is to be applied, or that only a certain fraction of cylinders are to be utilized when compression braking. Accordingly, the system capability module 204 adjusts the compression braking capacity 212 to reflect the reduced capability of the engine compression braking system.

In an exemplary embodiment, the braking control module 206 further provides the regenerative braking command 214 as a minimum between the regenerative braking capacity 210 and the braking request value 208. In one form, the braking control module 206 provides the mechanical braking command 234 as a minimum between the mechanical braking capacity 228 and a supplemental braking request value 244, where the supplemental braking request value 244 is a difference between the braking request value 208 and the regenerative braking capacity 210. In certain embodiments, the system capability module 204 further interprets the regenerative braking capacity 210 in response to a state of charge of an electrical storage device.

The operational descriptions which follow provides illustrative embodiments of performing procedures for managing hybrid power train braking. Operations illustrated are understood to be exemplary only, and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

An exemplary procedure for managing hybrid power train braking includes an operation to interpret an operator braking request value and an operation to determine a regenerative braking capacity. The procedure includes, in response to the regenerative braking capacity being lower than the operator braking request value, an operation to determine a supplemental braking request value and a mechanical braking capacity. In response to the mechanical braking capacity being lower than the supplemental braking request value, the method includes an operation to determine a friction braking value. The method further includes an operation to provide a regenerative braking command in response to the regenerative braking capacity and the operator braking request value, an operation to provide a mechanical braking command in response to the supplemental braking request value and the mechanical braking capacity, and an operation to provide a friction braking command in response to the friction braking value.

Certain additional or alternative operations of the exemplary procedure are described following. The procedure includes an operation to provide the regenerative braking command by determining a minimum between the regenerative braking capacity and the operator braking request value. An exemplary procedure includes an operation to determine the supplemental braking request value by subtracting the regenerative braking capacity from the operator braking request value. A further embodiment includes an operation to provide the mechanical braking command by determining a minimum between the mechanical braking capacity and the supplemental braking request value.

An exemplary procedure further includes an operation to determine the friction braking value by subtracting the sum of the regenerative braking capacity and the mechanical braking capacity from the operator braking request value. In one form, the procedure includes an operation to determine the friction braking value by subtracting the regenerative braking command and the mechanical braking command from the operator braking request value.

The operation to interpret the operator braking request value includes determining a brake pedal position, and/or determining an operator negative torque request. In certain embodiments, exemplary mechanical braking commands include an engine compression braking command, an exhaust throttle command, an exhaust brake command, a variable geometry turbocharger command, and/or a hydraulic retarder command.

Yet another exemplary procedure for managing hybrid power train braking follows. The exemplary procedure includes an operation to interpret an operator braking request value and an operation to provide braking commands to achieve the operator braking request value. The operation to provide braking commands includes, in order, providing a maximum available regenerative braking command, then a maximum available mechanical braking command, and then a friction braking command, until the operator braking request value is achieved. Another exemplary procedure includes an operation to provide the mechanical braking command as an engine compression braking command. Yet another exemplary embodiment includes an operation to determine that engine compression braking is unavailable, and an operation to provide an alternate mechanical braking command in response to the engine compression braking being unavailable. The alternate braking command, in one form, is a variable geometry turbocharger (VGT) command. Additionally or alternatively, the alternate braking command is a hydraulic retarder braking command, and/or an exhaust braking command.

Exemplary mechanical braking commands include an exhaust braking command, a variable geometry turbocharger command, and/or a hydraulic retarder command. An exemplary method includes interpreting an anti-lock braking command modification, and adjusting the operator braking request value in response to the anti-lock braking command modification.

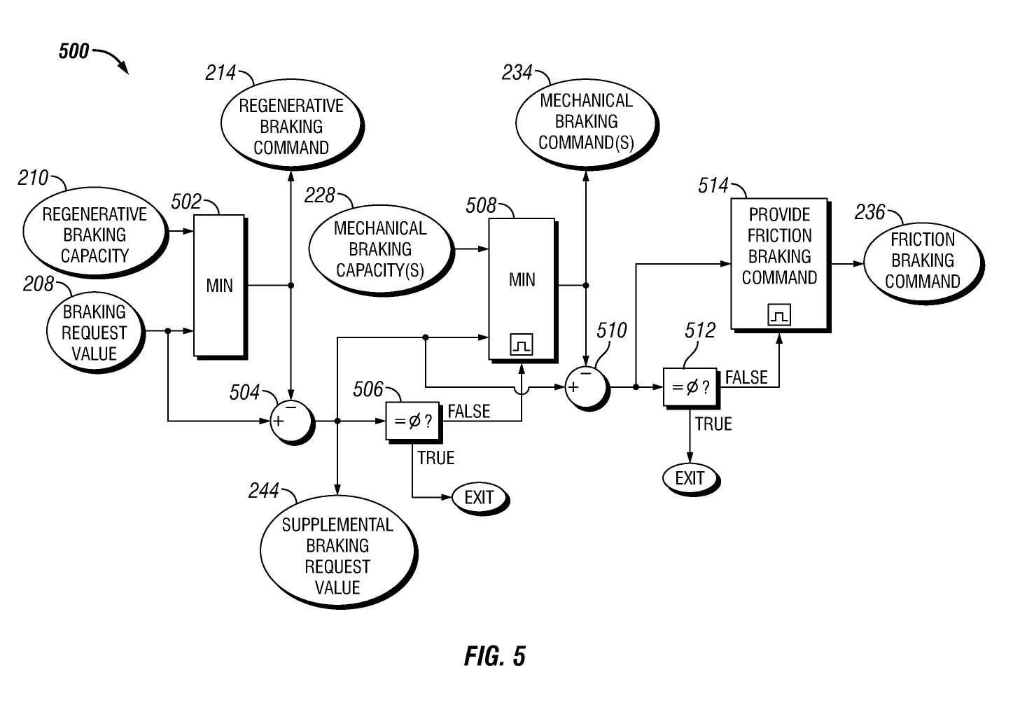

Referencing FIG. 5, a schematic exemplary control logic diagram 500 for managing hybrid power train braking is illustrated. The control logic commences with an operation 502 to determine a minimum value between the regenerative braking capacity 210 and the braking request value 208. The output of the minimum operation 502 is provided as the regenerative braking command 214. The control logic continues with an operation 504 to determine a difference between the braking request value 208 and the regenerative braking command 214. The output of the difference operation 504 is the supplemental braking request value 244. The control logic continues with determining whether any additional braking torque is required, with an operation 506 to determine if the supplemental braking request value 244 is zero.

In response to the supplemental braking request value 244 being zero, the regenerative braking command 214 is sufficient and the control logic exits. In response to the supplemental braking request value 244 not being zero, the control logic continues with executing an operation 508 to determine a minimum between a mechanical braking capacity 228 and the supplemental braking request value 244. The operation 508 may be determined against the entire mechanical braking capacity 228 as shown, and/or may be sequentially applied to each mechanical braking device available, with the supplemental braking request value 244 being reduced as each mechanical braking device is determined to apply a braking amount, until the braking request value 208 is achieved. The output of the minimum operation 508 is the mechanical braking command 234, or the various individual braking commands for the available devices.

The control logic continues with a difference operation 510 to determine a difference between the mechanical braking command(s) 234 and the supplemental braking request value 244. Where the difference operation 512 indicates that the mechanical braking command 234 is equal to the supplemental braking request value 244, the braking request value 208 is met and the control logic exits. Where the difference operation 512 indicates that further braking torque is required, the control logic enables operation 514 that provides the friction braking command 236 equal to the remaining unmet braking request value 208.

As is evident from the figures and text presented above, a variety of embodiments according to the present invention are contemplated.

An exemplary set of embodiments is a method including interpreting an operator braking request value and determining a regenerative braking capacity. The method includes, in response to the regenerative braking capacity being lower than the operator braking request value, determining a supplemental braking request value and a mechanical braking capacity. In response to the mechanical braking capacity being lower than the supplemental braking request value, the method includes determining a friction braking value. The method further includes providing a regenerative braking command in response to the regenerative braking capacity and the operator braking request value, providing a mechanical braking command in response to the supplemental braking request value and the mechanical braking capacity, and providing a friction braking command in response to the friction braking value.

Certain additional or alternative embodiments of the exemplary method are described following. The method includes providing the regenerative braking command by determining a minimum between the regenerative braking capacity and the operator braking request value. An exemplary method includes determining the supplemental braking request value by subtracting the regenerative braking capacity from the operator braking request value. A further embodiment includes providing the mechanical braking command by determining a minimum between the mechanical braking capacity and the supplemental braking request value.

An exemplary method includes determining the friction braking value by subtracting the sum of the regenerative braking capacity and the mechanical braking capacity from the operator braking request value. In one form, the method includes determining the friction braking value by subtracting the effective braking torque generated from the regenerative braking command and the effective braking torque generated from the mechanical braking command from the operator braking request value.

The operation to interpret the operator braking request value includes determining a brake pedal position, and/or determining an operator negative torque request. In certain embodiments, the regenerative braking command includes an electrical generator braking command and/or a hydraulic motor (or turbine, pump, etc.) braking command. In certain embodiments, exemplary mechanical braking commands include an engine compression braking command, an exhaust throttle command, an exhaust brake command, a variable geometry turbocharger command, and/or a hydraulic retarder command.

Another exemplary set of embodiments is a method including interpreting an operator braking request value and providing braking commands to achieve the operator braking request value. The operation to provide braking commands includes, in order, providing a maximum available regenerative braking command, then a maximum available mechanical braking command, and then a friction braking command, until the operator braking request value is achieved. In certain embodiments, the method includes providing the braking command(s) by determining an effective gear ratio between the operator braking request value and each one of the commanded devices corresponding to the maximum available regenerative braking command, the maximum available mechanical braking command, and/or the friction braking command.

The effective gear ratio is any torque multiplication value that allows proper conversion between the individual braking torque values and the operator braking request value. In certain embodiments, the effective gear ratio accounts for a current gear ratio of a transmission, for example where one or more of the braking devices is positioned mechanically upstream of a transmission and the braking load is positioned downstream of the transmission. An effective gear ratio may account for rear axle ratios, a continuously variable transmission, dynamic action of a torque converter, and for any other devices in the system according to the mechanical position of the braking load and the respective braking device.

Another exemplary method includes providing the mechanical braking command as an engine compression braking command. Yet another exemplary embodiment includes determining that engine compression braking is unavailable, and providing an alternate mechanical braking command in response to the engine compression braking being unavailable. The alternate braking command, in one form, is a variable geometry turbocharger (VGT) command. Additionally or alternatively, the alternate braking command is a hydraulic retarder braking command, and/or an exhaust braking command.

Exemplary mechanical braking commands include an exhaust braking command, a variable geometry turbocharger command, and/or a hydraulic retarder command. An exemplary method includes interpreting an anti-lock braking command modification, and adjusting the operator braking request value in response to the anti-lock braking command modification.

Yet another exemplary set of embodiments is a system including a hybrid power train having an internal combustion engine and a motor selectively coupled to a drive shaft, an energy converter selectively coupled to the drive shaft and further coupled to an energy accumulation device, and a negative torque request device that provides a braking request value. An exemplary negative torque request device comprises a brake pedal position sensor. The system further includes a controller having modules structured to functionally execute operations for managing hybrid power train braking. The controller includes a negative torque module that interprets the braking request value, a system capability module that interprets a regenerative braking capacity and a mechanical braking capacity, and a braking control module that provides a regenerative braking command, a mechanical braking command, and a friction braking command in response to the braking request value, the regenerative braking capacity, and the mechanical braking capacity.

Certain additional or alternative embodiments of the system are described following. In certain embodiments, the system includes a transmission mechanically positioned between the internal combustion engine and the motor. In further embodiments, the system capability module interprets the regenerative braking capacity and/or the mechanical braking capacity in response to an effective gear ratio of the transmission. For example, if the regenerative braking capacity is normalized to equivalent torque generated by an engine compression brake on the engine crankshaft, the regenerative braking capacity as a torque limit is adjusted by the effective gear ratio of the transmission (which may account for a torque converter, etc.). Where the regenerative braking capacity is limited by presently available energy storage (e.g. in a hydraulic accumulator, battery pack, ultra-capacitor, capacity of a vehicle electrical system to accept electrical energy input, etc.), the system capability module may or may not utilize the effective gear ratio of the transmission. In one example, the total amount of work available to be stored by the energy storage is utilized to limit the regenerative braking capacity, and is not affected by the effective gear ratio of the transmission.

In certain embodiments, one or more mechanical braking devices are positioned upstream of the transmission, and the system capability module interprets the mechanical braking capacity in response to the effective gear ratio of the transmission to convert the mechanical braking capacity to an equivalent transmission tailshaft torque, and/or to an equivalent braking load torque (accounting for any intervening torque multiplication devices), and/or to any other selected torque standard. In certain embodiments, where the one or more mechanical devices affect torque at a standard or calibrated position (e.g. at the engine crankshaft), the system capability module does not adjust the mechanical braking capacity in response to the effective gear ratio of the transmission. In certain embodiments, the negative torque module interprets the braking request value in response to the effective gear ratio of the transmission. It is a mechanical step for one of skill in the art, having the benefit of the disclosures herein, to interpret the braking request value, the regenerative braking capacity, and/or the mechanical braking capacity in response to the effective gear ratio of the transmission.

In certain embodiments, the motor is an electrical motor and the energy converter is a generator. The electrical motor and the generator may be separate devices or the same device, for example as an electric motor/generator. In certain further embodiments, the energy accumulation device includes one or more electrical storage devices, including without limitation a battery pack, an ultra-capacitor, and/or an ongoing demand for a vehicle electrical system.

In certain additional or alternative embodiments, the energy converter includes a hydraulic power recovery unit. The hydraulic power recovery unit includes any device capable to convert load energy, for example kinetic vehicle energy, into hydraulic power. Exemplary and non-limiting hydraulic power recovery units include a hydraulic motor, a hydraulic turbine, and/or a hydraulic pump. An example system further includes the motor as a hydraulic device, which may also be the hydraulic recovery unit. An example system further includes the energy accumulation device as a hydraulic accumulator. While a hydraulic accumulator is contemplated herein, the storage of the converted energy from the hydraulic power recovery unit may be in any form.

The exemplary system includes the drive shaft mechanically coupling the hybrid power train to a vehicle drive wheel. In certain embodiments, the system includes a mechanical braking device that is responsive to the mechanical braking command. Exemplary mechanical braking devices include a compression braking device, an exhaust throttle, an exhaust brake, a variable geometry turbocharger, and/or a hydraulic retarder.

In one form, the braking control module provides the regenerative braking command, the mechanical braking command, and the friction braking command by maximizing, in order, first the regenerative braking command and then the mechanical braking command, until the braking request value is achieved. In certain embodiments, the system includes an anti-lock brake system structured to provide an anti-lock braking command modification, wherein the negative torque module is further structured to interpret the anti-lock braking command modification and to adjust the braking request value in response to the anti-lock braking command modification.

Yet another exemplary set of embodiments is an apparatus for managing hybrid power train braking. The apparatus includes a negative torque module that interprets a braking request value, a system capability module that interprets a regenerative braking capacity and a mechanical braking capacity, and a braking control module that provides a regenerative braking command, a mechanical braking command, and a friction braking command in response to the braking request value, the regenerative braking capacity, and the mechanical braking capacity. Certain additional or alternative embodiments of the apparatus are described following.

An exemplary apparatus includes the braking control module further providing the regenerative braking command as a minimum between the regenerative braking capacity and the braking request value. In one form, the braking control module provides the mechanical braking command as a minimum between the mechanical braking capacity and a supplemental braking request value, where the supplemental braking request value is a difference between the braking request value and the regenerative braking capacity. In certain embodiments, the system capability module further interprets the regenerative braking capacity in response to a state of charge of an electrical storage device.

Yet another exemplary set of embodiments is a system including a vehicle having a drive wheel mechanically coupled to a drive shaft of a hybrid power train, where the hybrid power train includes an internal combustion engine and an electric motor selectively coupled to the drive shaft. The exemplary internal combustion engine includes a compression braking device. The system further includes an electric generator selectively coupled to the drive shaft and further coupled to an electrical storage device, and a brake pedal position sensor that provides a braking request value.

The system further includes a controller having modules structured to functionally execute operations for managing hybrid power train braking. The exemplary controller includes a negative torque module that interprets the braking request value, a system capability module that interprets a regenerative braking capacity and a compression braking capacity, and a braking control module that provides a regenerative braking command and a compression braking command in response to the braking request value, the regenerative braking capacity and the compression braking capacity.

In certain embodiments, the internal combustion engine includes a VGT, and the system capability module interprets a VGT braking capacity. The braking control module further provides the regenerative braking command, the compression braking command, and a VGT braking command in response to the VGT braking capacity. In certain further embodiments, the system includes a compression braking disable switch that provides a compression braking disable switch signal, and the system capability module further interprets the compression braking capacity in response to the compression braking disable switch signal.

In one form, the system includes an anti-lock braking system that provides an anti-lock braking command modification. The negative torque module further interprets the anti-lock braking command modification and adjusts the braking request value in response to the anti-lock braking command modification. In certain embodiments, the hybrid power train further includes a hydraulic retarder, and the system capability module is further interprets a hydraulic retarder braking capacity. The braking control module provides the regenerative braking command, the compression braking command, and a hydraulic retarder braking command in response to the hydraulic retarder braking capacity.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
interpreting an operator braking request value;
determining a regenerative braking capacity;
in response to the regenerative braking capacity being lower than the operator braking request value, determining a supplemental braking request value and a mechanical braking capacity;
in response to the mechanical braking capacity being lower than the supplemental braking request value, determining a friction braking value; and
providing a regenerative braking command in response to the regenerative braking capacity and the operator braking request value;
providing a mechanical braking command in response to the supplemental braking request value and the mechanical braking capacity; and
providing a friction braking command in response to the friction braking value.

2. The method of claim 1, wherein the providing the regenerative braking command comprises determining a minimum between the regenerative braking capacity and the operator braking request value.

3. The method of claim 1, wherein the determining the supplemental braking request value comprises subtracting the regenerative braking capacity from the operator braking request value.

4. The method of claim 3, wherein the providing the mechanical braking command comprises determining a minimum between the mechanical braking capacity and the supplemental braking request value.

5. The method of claim 1, wherein the determining the friction braking value comprises subtracting the sum of the regenerative braking capacity and the mechanical braking capacity from the operator braking request value.

6. The method of claim 1, wherein the determining the friction braking value comprises subtracting the regenerative braking command and the mechanical braking command from the operator braking request value.

7. The method of claim 1, wherein the interpreting the operator braking request value comprises determining a brake pedal position.

8. The method of claim 1, wherein the interpreting the operator braking request value comprises determining an operator negative torque request.

9. The method of claim 1, wherein the mechanical braking command comprises at least one command selected from the commands consisting of: an engine compression braking command, an exhaust throttle braking command, an exhaust brake command, a variable geometry turbocharger braking command, and a hydraulic retarder command.

10. A method, comprising:
interpreting an operator braking request value;
providing braking commands to achieve the operator braking request value; and
wherein the providing braking commands comprises, in order, providing a maximum available regenerative braking command, a maximum available mechanical braking command, and a friction braking command.

11. The method of claim 10, wherein the providing the braking commands comprises determining an effective gear ratio between the operator braking request value and each one of a plurality of commanded devices responsive to a corresponding one of the maximum available regenerative braking command, the maximum available mechanical braking command, and the friction braking command.

12. The method of claim 10, wherein the mechanical braking command comprises an engine compression braking command.

13. The method of claim 12, further comprising determining that engine compression braking is unavailable, and providing an alternate mechanical braking command in response to the engine compression braking being unavailable.

14. The method of claim 13, wherein the alternate mechanical braking command comprises a variable geometry turbocharger braking command.

15. The method of claim 10, wherein the mechanical braking command comprises an exhaust braking command.

16. The method of claim 10, wherein the mechanical braking command comprises a variable geometry turbocharger braking command.

17. The method of claim 10, wherein the mechanical braking command comprises a hydraulic retarder command.

18. The method of claim 10, further comprising interpreting an anti-lock braking command modification, and adjusting the operator braking request value in response to the anti-lock braking command modification.

19. A system, comprising:
a hybrid power train having an internal combustion engine and a motor selectively coupled to a drive shaft;
an energy converter selectively coupled to the drive shaft and further coupled to an energy accumulation device;
a negative torque request device structured to provide a braking request value;
a controller, comprising:
a negative torque module structured to interpret the braking request value;
a system capability module structured to interpret a regenerative braking capacity and a mechanical braking capacity; and
a braking control module structured to provide a regenerative braking command, a mechanical braking command, and a friction braking command in response to the braking request value, the regenerative braking capacity, and the mechanical braking capacity.

20. The system of claim 19, further comprising a transmission mechanically disposed between the internal combustion engine and the motor.

21. The system of claim 20, wherein the system capability module is further structured to interpret the regenerative braking capacity and the mechanical braking capacity in response to an effective gear ratio of the transmission.

22. The system of claim 20, wherein the braking control module is structured to provide the regenerative braking command, the mechanical braking command, and the friction braking command further in response to an effective gear ratio of the transmission.

23. The system of claim 19, wherein the motor comprises an electrical motor, wherein the energy converter comprises a generator, and wherein the energy accumulation device comprises an electrical energy storage device.

24. The system of claim 19, wherein the energy converter comprises a hydraulic power recovery unit.

25. The system of claim 24, wherein the energy accumulation device comprises a hydraulic accumulator.

26. The system of claim 19, wherein the drive shaft mechanically couples the hybrid power train to a vehicle drive wheel.

27. The system of claim 19, further comprising a mechanical braking device that is responsive to the mechanical braking command.

28. The system of claim 27, wherein the mechanical braking device comprises at least one device selected from the list of devices consisting of: a compression braking device, an exhaust throttle, an exhaust brake, a variable geometry turbocharger, and a hydraulic retarder.

29. The system of claim 19, wherein the braking control module is structured to provide the regenerative braking command, the mechanical braking command, and the friction braking command by maximizing, in order, the regenerative braking command and the mechanical braking command, until the braking request value is achieved.

30. The system of claim 19, further comprising an anti-lock brake system structured to provide an anti-lock braking command modification, wherein the negative torque module is further structured to interpret the anti-lock braking command modification and to adjust the braking request value in response to the anti-lock braking command modification.

31. The system of claim 19, wherein the negative torque request device comprises a brake pedal position sensor.

32. An apparatus, comprising:
a negative torque module structured to interpret a braking request value;
a system capability module structured to interpret a regenerative braking capacity and a mechanical braking capacity; and
a braking control module structured to provide a regenerative braking command, a mechanical braking command, and a friction braking command in response to the braking request value, the regenerative braking capacity, and the mechanical braking capacity.

33. The apparatus of claim 32, wherein the braking control module is further structured to provide the regenerative braking command as a minimum between the regenerative braking capacity and the braking request value.

34. The apparatus of claim 33, wherein the braking control module is further structured to provide the mechanical braking command as a minimum between the mechanical braking capacity and a supplemental braking request value, the supplemental braking request value comprising a difference between the braking request value and the regenerative braking capacity.

35. The apparatus of claim 33, wherein the system capability module is further structured to interpret the regenerative braking capacity in response to a state of charge of an electrical storage device.

36. A system, comprising:
a vehicle having a drive wheel mechanically coupled to a drive shaft of a hybrid power train;
the hybrid power train comprising an internal combustion engine and an electric motor selectively coupled to the drive shaft, the internal combustion engine including a compression braking device;
an electric generator selectively coupled to the drive shaft and further coupled to an electrical storage device;
a brake pedal position sensor structured to provide a braking request value; and
a controller, comprising:
a negative torque module structured to interpret the braking request value;
a system capability module structured to interpret a regenerative braking capacity and a compression braking capacity; and
a braking control module structured to provide a regenerative braking command and a compression braking command in response to the braking request value, the regenerative braking capacity and the compression braking capacity.

37. The system of claim 36, wherein the internal combustion engine further comprises a variable geometry turbocharger (VGT), wherein the system capability module is further structured to interpret a VGT braking capacity, and wherein the braking control module is further structured to provide the regenerative braking command, the compression braking command, and a VGT braking command in response to the VGT braking capacity.

38. The system of claim 37, further comprising a compression braking disable switch that provides a compression braking disable switch signal, wherein the system capability module is further structured to interpret the compression braking capacity in response to the compression braking disable switch signal.

39. The system of claim 36, further comprising an anti-lock braking system that provides an anti-lock braking command modification, wherein the negative torque module is further structured to interpret the anti-lock braking command modification and to adjust the braking request value in response to the anti-lock braking command modification.

40. The system of claim 36, wherein the hybrid power train further comprises a hydraulic retarder, wherein the system capability module is further structured to interpret a hydraulic retarder braking capacity, and wherein the braking control module is further structured to provide the regenerative braking command, the compression braking command, and a hydraulic retarder braking command in response to the hydraulic retarder braking capacity.
